(19) United States
(12) Patent Application Publication
(10) Pub. No.: US 2004/0123945 A1
(43) Pub. Date: Jul. 1, 2004

(54) Method for making batches of printed multilayer films

(76) Inventors: Frederic Stagnitto, Saint-Denis-De-L'Hotel (FR); Jean Luc Poirier, Saint-Denis-De-L'Hotel (FR)

Correspondence Address: FULBRIGHT & JAWORSKI, LLP, 1301 MCKINNEY, SUITE 5100, HOUSTON, TX, 77010-3095, US

(21) Appl. No.: 10/399,245

(22) PCT Filed: Oct. 26, 2001
(86) PCT No.: PCT/FR01/03330

(30) Foreign Application Priority Data
Oct. 26, 2000 (FR) 0013727

(51) Int. Cl. B32B 31/00; B41M 1/00

(52) U.S. Cl. 156/277; 156/272.2

(57) ABSTRACT

The invention relates to a method of manufacturing batches of multilayer laminated films bearing a printed graphic visual image, for making packaging intended in particular to contain food products, the method comprising a step (30) of reverse printing the transparent outer layer of the films and then a phase (31) of assembling the film layers, characterized in that the visual image of the various batches comprise common graphic elements, in that, during the reverse printing step, only the said common graphic elements are printed and in that, after the phase of assembling the film layers, a second step (32) of printing graphic elements specific to each batch of films is carried out.

The present invention relates in general to the operations of manufacturing packagings comprising laminated materials bearing a graphic print.

The invention thus relates to a method of manufacturing batches of multilayer laminated films, and to batches of films obtained by such a method.

Laminated materials are defined as materials which are in the form of composite films, each film being produced by assembling at least two layers of materials such as a plastic or a light metal, it being possible for each layer of the film to be made from a different material.

In a preferred but non-limiting application of the invention, flexible pouches intended to contain food products such as animal feed are thus constructed.

Pouches of this sort are usually constructed by joining two flexible sheets, the edges of which are welded in order to close the pouch; they may or may not comprise a bottom gusset; the two sheets may form a single sheet folded back on itself. The sheets are obtained by cutting the films to the required dimensions.

A known structure for each sheet of the pouch comprises an inner layer of material which can be welded, a transparent outer layer acting as a graphic printing medium, and an intermediate layer made of a light metal such as aluminium.

In this text, the terms “inner” and “outer” referring to the faces of the layers and of the films are to be understood in relation to the pouch once it is constructed: an “inner” layer is that which is turned towards the centre of the pouch, an “outer” layer being oriented towards the outside of the pouch.

The primary function of the inner layer is to provide the mechanical strength and sealing of the pouch. It may, for example, be made of polypropylene, and have a thickness of about 40 to 200 microns, or else of polyethylene or of a light metal such as aluminium and have a thickness of about 6 to 20 microns. The inner face of this layer may be coated with a welding lacquer.

As for the outer layer, this serves as a medium for printing visual images. It may also be made of polyester, polyethylene or polypropylene.

Furthermore, each film may also comprise additional layers. Thus films for pouches comprising an aluminium layer inserted between an inner layer providing the mechanical strength and an outer layer acting as a printing medium are known.

To print graphic elements which may comprise drawings, photos and text on the outer layer, it is known to use two main types of method.

The first type of method, called direct printing, first of all consists in assembling the layers in order to construct the films of the pouch, then in printing the required graphic patterns on the outer surface of these films.

More specifically, in an industrial environment, each film is not directly manufactured individually, but first of all, master spools of laminated film are constructed from spools of the various layers of the film, after which these master spools are cut into production spools, which will themselves be cut into sheets of dimensions required to construct the pouches.

The cutting into shets can be done by the manufacturer who manufactures the production spools, who will then assemble the sheets in order to construct pouches ready to be filled, or by another manufacturer who receives these production spools and cuts the sheet, constructs the pouches and fills and closes these pouches, on the same site.

The layers are assembled by adhesive bonding and laminating, and it is necessary to wait for this assembly to dry before printing on the outer face of the outer layer of the film.

The drying time needed to obtain good strength of the layers of the film is generally of the order of a few days, and may exceed a week in some cases (depending on the drying conditions and adhesives used).

This first type of method has the advantage of being particularly flexible: films may be constructed in advance by adhesive bonding and lamination of the layers, then these films can be quickly printed with suitable graphic elements.

This ensures considerable ability to react in response to requests for pouches bearing various types of print.

However, direct printing nevertheless has drawbacks: the printed graphic elements, being borne by the outer face of the film, are directly exposed to scratches and impairment that may result from handling and other treatments (sterilization by heating or other means), such that the print is likely to be damaged.

Also, such damage would be detrimental to the presentation of the pouch, especially for some graphic elements whose appearance it is desired to protect (logo or photo showing a trademark image, for example).

Furthermore, the cost of losses associated with direct printing may be quite high. This is because, since this printing takes place on films which are already adhesively bonded and held together, any printing fault means that these laminated films have to be discarded. The same goes for the parts of film used when adjusting and setting up the printing machines, which the manufacturer will have to discard.

A second type of known method, called reverse printing, consists in printing the graphic elements on the inner face of the outer layer of the films before assembling this layer to an inner layer.

The inner face of this outer layer acting as a graphic medium can be printed by various techniques, for example gravure or flexographic printing.

Also, since this outer layer is transparent, the graphic elements printed on its inner face are visible from the outside of the pouch. In addition, the presence of the transparent outer layer which may, as has been said, be made for example of polyester, polyethylene or polypropylene, and which covers the printed graphic elements, thereby protecting them, provides a glossy appearance such that it is not necessary to coat the outer surface of the films constructed in this way with a lacquer (as may be the case for direct printing).

After this printing, the outer layer is assembled to the inner layers by adhesive bonding and lamination, in order to construct the film which will be used to construct the pouches.

This type of method makes it possible to protect the printed elements, since the thickness of the outer layer protects the printing from scratches and other damage.

However, this second type of method means having to print the graphic elements before carrying out the operations of adhesively bonding, drying and laminating the films, so that, once the specifications for printing a pouch to be manufactured are known, the printing and then the construction of the films still have to be carried out, which considerably extends the implementation of the method.

One aim of the invention is to make it possible to produce printed packagings such as pouches, while offering features of print quality, savings and ability to react which none of the known methods provide.

Another aim of the invention is to make it possible to combine to some extent at least the advantages of the known types of printing methods, but without entailing the same drawbacks.

In order to achieve these aims, the invention provides a method of manufacturing batches of multilayer laminated films bearing a printed graphic illustration, for making packaging intended in particular to contain food products, the method comprising a step of reverse printing the transparent outer layer of the films and then a phase of assembling the film layers, characterized in that the visual images of the various batches comprise common graphic elements, in that, during the reverse printing step, only the said common graphic elements are printed and in that, after the phase of assembling the film layers, a second step of printing graphic elements specific to each batch of films is carried out.

Preferred, but non-limiting aspects of the method according to the invention are as follows:

the second printing step is carried out by direct printing on the outer face of the films,

the phase of assembling the film layers comprises a step of adhesively bonding the film layers, and a step of drying the adhesive,

the second printing step is carried out on films whose layers have been adhesively bonded, the adhesive between the layers having dried,

during the second printing step, only simple graphic elements, such as text and flat tints are printed,

the second printing step only uses a small number of colours,

the films comprise three layers,

the films comprise a central aluminium layer inserted between two layers, each of which may be made of polyester, polyethylene or polypropylene, independently of the other.

Other aspects, aims and advantages of the invention will become more clearly apparent following the following description of one embodiment of the invention, with reference to the appended drawings in which:

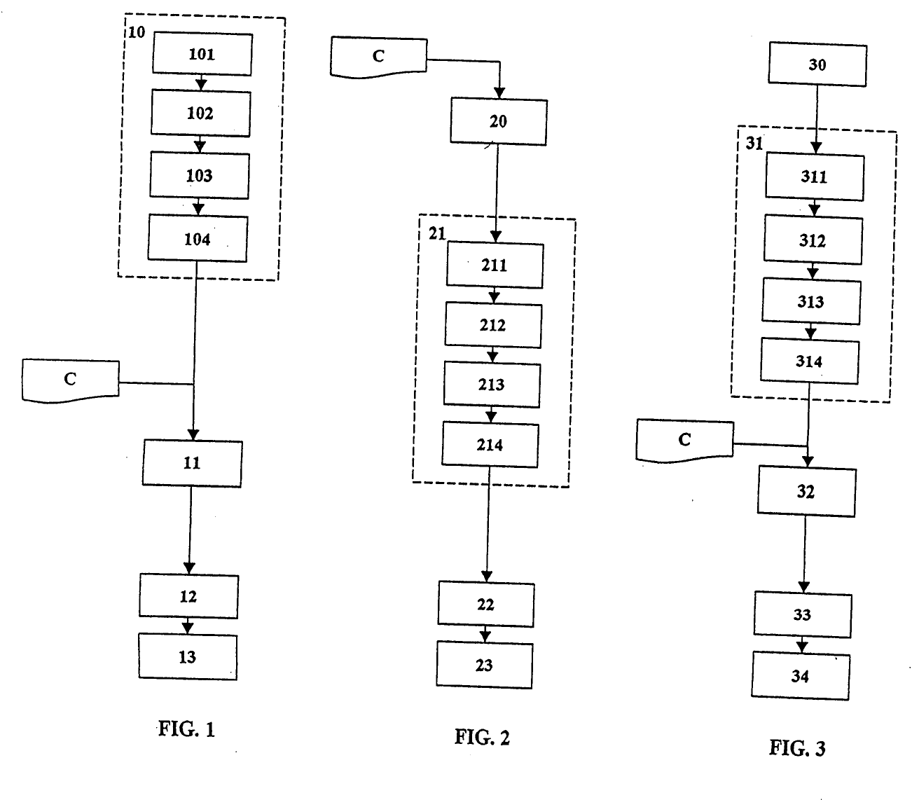

FIG. 1 is a flow chart detailing the main steps of constructing printed films by direct printing, in a known manner,

FIG. 2 is a flow chart detailing the main steps in constructing printed films by reverse printing, still in a known manner,

FIG. 3 is a flow chart detailing the main steps in constructing printed films by a method according to the invention.

First of all, the steps making it possible to construct films printed with the desired graphic elements, according to two known types of method, will be described briefly with reference to FIGS. 1 and 2.

FIG. 1 illustrates the use of direct printing. According to this type of method, firstly, a phase of assembling layers of laminated films, the outer face of which has no print, is carried out at 10.

In the example described here, the films which are manufactured and which will be used for constructing pouches comprise three layers (an aluminium layer inserted between a polyester layer and a polypropylene layer).

Consequently, this assembly phase 10 comprises:

a first adhesive bonding/lamination step 101 for rendering the layer of polypropylene integral with the aluminium layer. This step typically lasts two days in an industrial environment,

step 101 is followed by a first drying step 102 which also lasts about two days, in order to ensure that the aluminium and polypropylene layers are correctly rendered integral,

next, a second adhesive bonding/lamination step 103 is carried out, during which the aluminium layer and an additional polyester layer are rendered integral; this step lasts about two days,

finally, the laminate constructed in this way is left to dry for about fourteen days, at 104.

It may be mentioned that it is also possible firstly to adhesively bond the polyester and aluminium layers then, after drying these two layers, to adhesively bond the polypropylene layer so as to construct the same type of film with a central aluminium layer.

It is also possible to adhesively bond the three layers of the film in a single step.

On arrival of an order C, a stock of unprinted laminated films is thus available, which will be provided with the graphic elements specified in the order (these graphic elements will be denoted by the term “visual image”).

In this respect, it is important to specify that, for many applications, the orders do not relate to a single visual image, but require the manufacture of several batches of films each having a specific visual image.

More particularly, the various visual images of one order may comprise some common graphic elements such as the logo and the generic graphic background of a trademark, and specific graphic elements such as the printing, in the desired language, of information about the product or of the appropriate statutory or regulatory notices.

The various visual images of the order are printed at 11, using a technique of direct printing on the outer face of the outer layer of the films used during phase 10.

Finally, the films are cut at 12, and they are packaged and despatched at 13. The films are then ready to be cut into sheets which will be assembled in order to construct the pouches.

FIG. 2 illustrates the manufacture of films printed according to a reverse printing technique.

In this case, it is necessary to wait for the order C in order to start manufacturing films, since in this case the first step is the reverse printing at 20 of the inner face of the layer which will be located outside the films once the latter are assembled in order to construct the pouches.

Prior to this printing step, it is necessary in an industrial environment to programme the production of the films. As has been said, the order C may involve different visual images, which will be printed at 20.

Depending on the number of different visual images of the order and on the volumes involved, the step of processing the order and of programming/scheduling the printing and the manufacture will thus typically last ten days. So it is only at the end of this programme that the printing is carried out at 20.

The various visual images are thus printed by reverse printing at 20. This step lasts about five days for an order comprising several visual images and for industrial volumes.

Next, the films are then constructed during a phase 21 by assembling the outer layer, whose inner face has been printed, to two other layers. Phase 21 involves the steps 211 to 214, which correspond to the steps 101 to 104 described with reference to FIG. 1.

Also, the steps 22 and 23, which correspond respectively to the steps 12 and 13 already described, can be found.

It will be noted that it is also possible to carry out the phase 21 of constructing laminated films by assembling, adhesively bonding and laminating the three layers of the film in a single step.

The manufacture of films according to the invention will now be described with reference to FIG. 3.

According to the invention, the graphic elements common to the films likely to be manufactured are reverse-printed at 30. This printing is carried out on a transparent layer which may, for example, be made of polyester, polyethylene or polypropylene, and which is intended to be the outer layer of the films for the pouches.

As mentioned above, these common elements may comprise the logo and the generic graphic background of a trademark. These elements may comprise high-resolution images or patterns. Preferably, the step 30 is carried out using a sophisticated printing technique, of the gravure printing type, so as to construct a high-quality visual background.

More specifically, the printing at step 30 may use several colours, for example five or six colours, and comprise printing flat-tint areas.

The flat tints may involve special colours and may be used to mask the metallized appearance of the intermediate layer of the films which, as has been said, may be made of a light metal such as aluminium.

Next, films whose outer layer is coated on its inner face with common graphic elements, preferably using a high-quality printing technique, are constructed during a phase 31. These common elements are protected by the thickness of the transparent outer layer and are not likely to be damaged.

The phase 31 of film construction comprises the steps 311 to 314 which correspond to the steps 101 to 104 and 211 to 214, already described.

At the end of the steps 30 and of the phase 31, laminated films comprising printed graphic elements common to the visual images of the orders likely to be processed are thus available; in this way, it is possible to build up stocks of films while waiting for an order.

The stocks of non-customized films are built up according to long-term production plans submitted by the manufacturer's customers who use the sheets.

Each of the visual images of an order C thus comprises a common part which has already been printed at 30, and a specific part (language adaptation, etc.) which remains to be printed.

This specific part will be printed at 32 after receiving the order, by direct printing on the outer face of the outer layer of the film, the said outer layer being transparent.

For this printing, a simple printing technique will preferably be used for producing simple graphics and areas of text, the specific elements remaining to be printed preferably comprising only simple graphic elements such as text and flat-tint areas. This direct printing carried out at 32 will generally only involve two or three colours.

A transparent protective varnish may be deposited on the outer face of the films so that the specific graphic elements are also protected.

The films are then cut at 33 (for example, in order to construct the production spools), and they are packaged and despatched at 34.

Thus, it appears that the method of manufacturing printed films according to the invention makes it possible to combine the advantages:

of direct printing, that is to say mainly the ability to react in order to process a new order comprising visual images with a specific part; this is because after receiving an order, the programming/scheduling time is reduced to about two days, since there is no need to programme the reverse printing of the whole visual image of each film or the steps of manufacturing the film, but only simple operations of direct printing of simple graphic elements. These direct printing operations, carried out during step 32, last about five days, after which the cutting and packaging/despatch steps (steps 33 and 34) last about three days; thus, it is noticed that the time for manufacturing and despatching films which are completely printed and packaged is about ten days after receiving the order, while it was about forty-five days for the conventional reverse printing,

and of reverse printing (quality and protection of the printed visual images with regard to the common graphic elements).

Also, it is possible to optimize the graphics of the visual images such that, once the pouch is constructed, the specific graphic elements which will be printed by direct printing are at locations on the pouch which are little exposed to external contact.

In this way, the specific graphic elements will be unlikely to be damaged.

Also, the method provides great flexibility, which makes it easily possible to adapt at least some parts of the visual image of the pouches to the requirements of the customer and of the consumer.

It will be understood that the invention will be profitably used, for example, to construct visual backgrounds of a high-quality trademark by reverse printing, and to differentiate the films at the last minute by direct printing of text in a specific language, or with a flat tint of colour corresponding to a particular variety (such as animal feed, for example).

It is also understood that another benefit of the invention is to reduce the intermediate stocks of preprinted films (such as films printed by reverse printing) where quick order fulfillment is required; associated costs are thereby reduced, which decreases the cost of implementing the method.

Furthermore, according to the invention, the batches of films to be printed by reverse printing are larger (since they do not involve the specific elements and may in reality relate to several batches of films having different complete visual images), and the associated cost per pouch is decreased since the time for adjustment and finishing, together with the unit material losses (layers of films and ink, etc.) per pouch are much less.

Moreover, it will be understood that because the direct printing step, which is carried out on a laminated film which is a completely crosslinked finished material (the adhesive between the layers of film having dried), does not relate to the whole visual image on the pouches but only to simple patterns involving only two or three colours, the losses associated with this step are considerably reduced with respect to conventional direct printing.

This is because, given the simplicity of the graphic elements printed by direct printing according to the invention, the losses due to the setting up and adjustment operation are substantially decreased.

Also, since these losses generate significant costs because, as has been mentioned, they relate to films already comprising several layers rolled together, it is particularly advantageous to reduce them in this way.

Finally, it may be mentioned that, although the description above relates to the manufacture of printed laminated films intended to make pouches, the invention is also applicable to any type of printed packagings based on multilayer laminated films.

1. Method of manufacturing batches of multilayer laminated films bearing a printed graphic visual image, for making packaging intended in particular to contain food products, the method comprising a step (30) of reverse printing the transparent outer layer of the films and then a phase (31) of assembling the film layers, characterized in that the visual images of the various batches comprise common graphic elements, in that, during the reverse printing step, only the said common graphic elements are printed and in that, after the phase of assembling the film layers, a second step (32) of printing graphic elements specific to each batch of films is carried out.

2. Method according to claim 1, characterized in that the second printing step (32) is carried out by direct printing on the outer face of the films.

3. Method according to claim 1 or 2, characterized in that the phase of assembling the film layers comprises a step of adhesively bonding the film layers, and a step of drying the adhesive.

4. Method according to the preceding claim, characterized in that the second printing step is carried out on films whose layers have been adhesively bonded, the adhesive between the layers having dried.

5. Method according to one of the preceding claims, characterized in that, during the second printing step, only simple graphic elements, such as text and flat-tint areas, are printed.

6. Method according to the preceding claim, characterized in that the second printing step only uses a small number of colours.

7. Method according to one of the preceding claims, characterized in that the films comprise three layers.

8. Method according to the preceding claim, characterized in that the films comprise a central aluminium layer inserted between two layers, each of which may be made of polyester, polyethylene or polypropylene, each independently of the other.
